(19) United States
(12) Patent Application Publication
(10) Pub. No.: US 2009/0325006 A1
(43) Pub. Date: Dec. 31, 2009

(54) FUEL CELL SYSTEM

(76) Inventors: Ryosuke Yagi, Yokohama-shi (JP); Takahiro Suzuki, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/411,939

(22) Filed: Mar. 26, 2009

(30) Foreign Application Priority Data
Jun. 30, 2008 (JP) 2008-171200

(51) Int. Cl. H01M 8/04

(52) U.S. Cl. 429/13; 429/23; 429/24

(57) ABSTRACT

A fuel cell system is provided with a power generation unit including stacked cells. Cell voltage signals are output from predetermined ones of the cells. A load change is applied to the generation unit, wherein first connection in which the first load is connected to the generation unit is switched to a second connection in which a second load is connected to the generation unit. The cell voltage changes are detected from the cell voltage signals. Each of the voltage changes has an inherent voltage difference between a minimum voltage generated immediately after the load change and an output response voltage generated after a predetermined elapse of time from the generation of the minimum voltage. Control parameters falling within a predetermined voltage range, are selected from the inherent voltage differences, and an amount of fuel supplied to the generation unit is determined based on the control parameters.

### CROSS-REFERENCE TO RELATED APPLICATIONS

This application is based upon and claims the benefit of priority from prior Japanese Patent Application No. 2008-171200, filed Jun. 30, 2008, the entire contents of which are incorporated herein by reference.

### BACKGROUND OF THE INVENTION

1. Field of the Invention

The present invention relates to a fuel cell system controlling a solid polymer electrolyte fuel cell that uses a liquid as a fuel.

2. Description of the Related Art

A polymer electrolyte fuel cell is known to be also called a proton-exchange membrane fuel cell and to use a proton-conductive polymer membrane having ion conductivity as an electrolyte. Polymer electrolyte fuel cells (PEFCs) include direct methanol fuel cells (DMFC). Efforts have been made to develop a direct methanol fuel cell (DMFC) used as a small power source for potable devices for the following reasons: the direct methanol fuel cell (DMFC) requires no auxiliary device such as a vaporizer or humidifier, methanol is easier to handle than a gas fuel such as hydrogen, and the direct methanol fuel cell can be operated at low temperatures.

The direct methanol fuel cell (DMFC) includes a membrane electrode assembly (MEA). The membrane electrode assembly is made up of an anode (also called a fuel electrode), a cathode (also called an air electrode), and a solid polymer membrane sandwiched between the anode and the cathode, and the solid polymer membrane permeated by protons. A water solution of methanol is supplied to the anode. Air is supplied to the cathode. Reaction expressed by Formula (1) occurs in the anode. Electrochemical reaction between methanol and water generates carbon dioxide, protons, and electrons.

CH₃OH+H₂O→6H⁺+6e⁻+CO₂ (1)

Furthermore, reaction expressed by Formula (2) occurs in a cathode catalyst layer of the membrane electrode assembly, that is, in the cathode of MEA. Oxygen contained in air reacts with protons to generate water.

4H⁺+4e⁻+O₂→2H₂O (2)

Part of generated water migrates from the cathode to the anode via the solid polymer membrane. The remaining water is emitted into the air or accumulated in the cathode.

On the other hand, at the same time, methanol crossover occurs in which part of the methanol contained in the water solution of methanol supplied to the anode migrates from the anode to the cathode. Not only reaction expressed by Formula (2) but also reaction expressed by Formula (3) occurs in the cathode.

$${CH}_{3} OH + \frac{3}{2} {O}_{2} -> {CO}_{2} + 2 {H}_{2} O \qquad ( 3 )$$

When the methanol in the anode is consumed by the methanol crossover reaction expressed by Formula (3), there will be decreased an efficiency of fuel utilization. Here, the fuel utilization efficiency is defined as the ratio of the amount of methanol used for the anode reaction expressed by Formula (1) to the amount of methanol supplied to the MEA anode. Furthermore, the methanol crossover reduces an output from the cathode and thus power generation output.

Thus, efforts have been made to limit the amount of methanol crossover within a predetermined range. In JP-A 2007-165148 (KOKAI), it is disclosed that the amount of the methanol crossover is increased in proportion to the concentration of methanol supplied to the anode. Thus, efforts have been made to use a methanol concentration sensor to sense the concentration of methanol supplied to the anode to limit the methanol concentration within a predetermined range. Furthermore, in JP-A H05-258760 (KOKAI), there is provided an improved technique of sensing the temperature of a fuel tank installed adjacent to a power generation unit using a temperature sensor, to limit the temperature within a predetermined range. As described above, several techniques have been used to improve the fuel utilization efficiency and power generation efficiency. However, for a more compact system and an increased efficiency, it is required to miniaturize and simplify a system, sense the crossover, and increase and stabilize a sensing process speed.

To simplify the crossover sensing system, JP-A 2005-285628 (KOKAI) provides an improved technique of switching a load on the power generation unit from a closed circuit to an open circuit, and setting an output from the power generation unit, which is obtained a given time after the switching, to be an evaluation value, to sense the concentration based on the evaluation value. This sensing method sets the value of the output voltage from the power generation unit to be the evaluation value. This advantageously eliminates the need for a concentration sensor. However, the sensing method requires a given amount of time from the switching from the closed circuit to the open circuit until the concentration is sensed. Thus, increasing the sensing speed remains a challenge.

Additionally, the output voltage from the power generation unit is varied by aging degradation or the like. Thus, gaining stability remains a challenge. Thus, JP-A 2008-011863 (KOKAI) relating to the previous application proposes a technique wherein a load adjustment unit connected to the power generation unit changes a load on the power generation unit to sense the minimum voltage value of the power generation unit, which is obtained after the change, and an output response value which is output after the output of the minimum voltage value. Then, the difference between the sensed minimum voltage value and output response value is determined to be the evaluation value to predict the amount of methanol crossover. Like JP-A 2005-285628 (KOKAI), this technique sets the output response value from the power generation unit to be the evaluation value, thus advantageously eliminating the need for a concentration sensor. Furthermore, since the difference between the minimum voltage value and output resistance value obtained after the change in load is set to be the evaluation value, the difference is unlikely to vary even when the output value is varied by aging degradation, advantageously resulting in improved stability. However, if the power generation unit includes a plurality of cells, when a voltage error occurs in some cells, the voltage error may change the evaluation value. This may disadvantageously reduce the accuracy with which the possible methanol crossover is predicted.

That is, the conventional fuel cell system disadvantageously fails to limit the amount of methanol crossover within the predetermined range and thus to improve the power generation efficiency. Thus, in connection with a liquid fuel cell provided with a power generation unit composed of a plurality of cells, a fuel cell system has been desired, which enables a reduction in the size of the system, which allows the crossover to be stably sensed over a long term, and which can be operated at a high power generation efficiency over a long term.

### BRIEF SUMMARY OF THE INVENTION

According to one aspect of the present invention, there is provided a fuel cell system comprising:

a fuel tank receiving a fuel;

a mixture tank receiving a water solution of the fuel which corresponds to a dilution of the fuel;

a fuel supply unit which feeds the fuel from the fuel tank to the mixture tank;

a power generation unit configured to generate an electrical power and including cells which are stacked in the power generating unit, wherein each of the cells includes;
a membrane electrode assembly including an electrolytic membrane, an anode formed on the electrolytic membrane, and a cathode which is so formed on the electrolytic membrane as to face the anode through the electrolytic membrane,
an anode channel plate having a structure which allows to feed the fuel to the anode, and
a cathode channel plate having a structure which allows to feed air to the cathode;

a fuel circulation unit which feeds the water solution from the mixture tank to the anode through the anode channel plates;

an air supply unit which feeds the air to the cathodes through the cathode channel plates;

a load adjustment unit including first and second loads, which selects one of a first connection in which the first load is connected to the power generation unit, and a second connection in which the second load is connected to the power generation unit;

a voltage monitoring unit which monitors cell voltages output from predetermined ones of the cells to generate cell voltage signals;

a temperature adjustment unit which senses temperature of the power generation unit to control the temperature of the power generation unit; and

a control unit controlling the load adjustment unit to produce a load change in which the first connection is switched to the second connection, the control unit detecting cell voltage changes from the cell voltage signals, the voltage changes being produced in the predetermined ones of the cells respectively due to the load change, each of the voltage changes having an inherent voltage difference between a minimum voltage generated immediately after the load change and an output response voltage generated after a predetermined elapse of time from the generation of the minimum voltage, wherein the control unit selects control parameters falling within a predetermined voltage range and determines a control amount of the fuel supplied to the power generation unit based on the control parameters, and the predetermined voltage range is determined based on the distribution of the inherent voltage differences of the cells.

According to another aspect of the present invention, there is provided a method of controlling a fuel cell, the method controlling amount of fuel supplied to a power generation unit including cells which are stacked in the power generating unit, wherein each of the cells includes;
a membrane electrode assembly including an electrolytic membrane, an anode formed on the electrolytic membrane, and a cathode which is so formed on the electrolytic membrane as to face the anode through the electrolytic membrane,
an anode channel plate having a structure which allows to feed the fuel to the anode, and
a cathode channel plate having a structure which allows to feed air to the cathode;

the method comprising:

monitoring cell voltages output from predetermined ones of the cells to generate cell voltage signals respectively;

generating a load change in which a first connection is switched to a second connection, wherein a first load is connected to the power generation unit in the first connection, and a second load is connected to the power generation unit in the second connection;

detecting cell voltage changes from the cell voltage signals, the voltage changes being produced in the predetermined ones of the cells respectively due to the load change, each of the voltage changes having an inherent voltage difference between a minimum voltage generated immediately after the load change and an output response voltage generated after a predetermined elapse of time from the generation of the minimum voltage;

selecting control parameters falling within a predetermined voltage range from the inherent voltage differences, wherein the predetermined voltage range is determined based on the distribution of the inherent voltage differences of the cells; and

determining a control amount of fuel supplied to the power generation unit based on the control parameters.

### BRIEF DESCRIPTION OF THE SEVERAL VIEWS OF THE DRAWING

FIG. 1 is a block diagram schematically showing a fuel cell system according to a first embodiment of the present invention;

FIGS. 2A and 2B are sectional views schematically showing a cell stack structure in a power generation unit shown in FIG. 1;

FIG. 3 is a graph showing a cell voltage response characteristic depending on a load current from the cell stack structure shown in FIG. 1, which is stepwise changed;

FIG. 4 is a graph showing a relationship between a voltage difference ΔV2 in a fuel cell in the power generation unit shown in FIG. 1 and a crossover current;

FIG. 5 is a distribution diagram showing an example of a distribution of the voltage differences ΔV2 in the fuel cells in the power generation unit shown in FIG. 1;

FIG. 6 is a flowchart showing crossover control performed in a control unit shown in FIG. 1;

FIG. 7 is a flowchart of control based on a cell voltage resulting from a load change in the system shown in FIG. 1;

FIG. 8 is a flowchart showing control in a defective-cell recovery method performed in the control unit shown in FIG. 1;

FIG. 9 is a block diagram schematically showing a fuel cell system according to a third embodiment; and

FIG. 10 is a flowchart showing a control loop in which the system shown in FIG. 9 senses and recovers a defective cell.

### DETAILED DESCRIPTION OF THE INVENTION

A fuel cell system according to an embodiment of the present invention will be described with reference to the accompanying drawings.

### First Embodiment

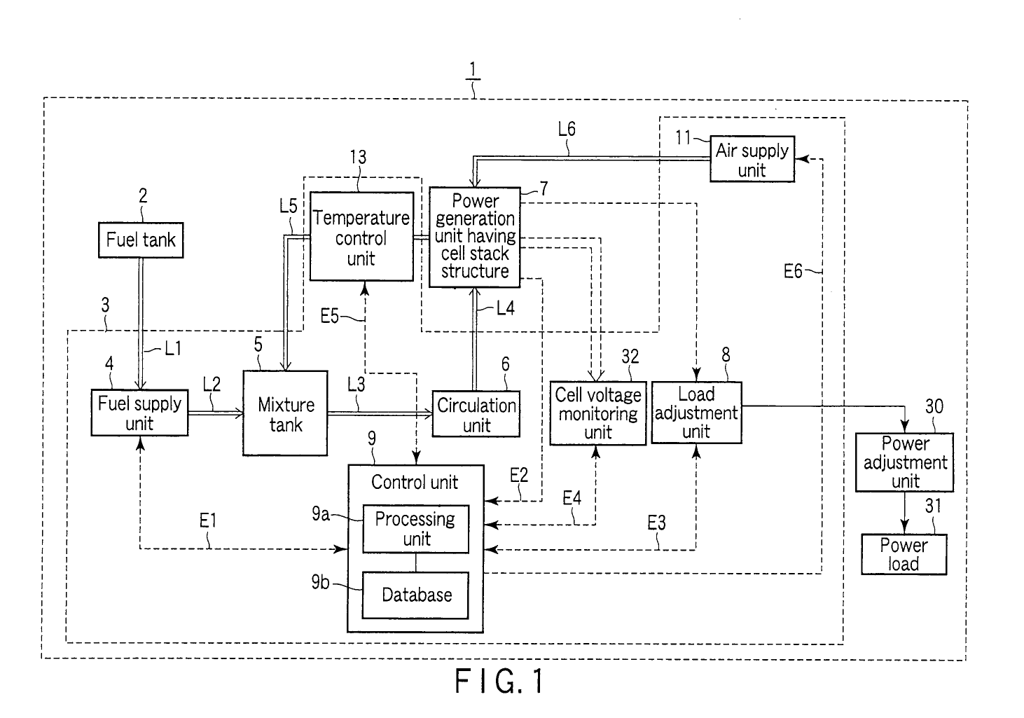

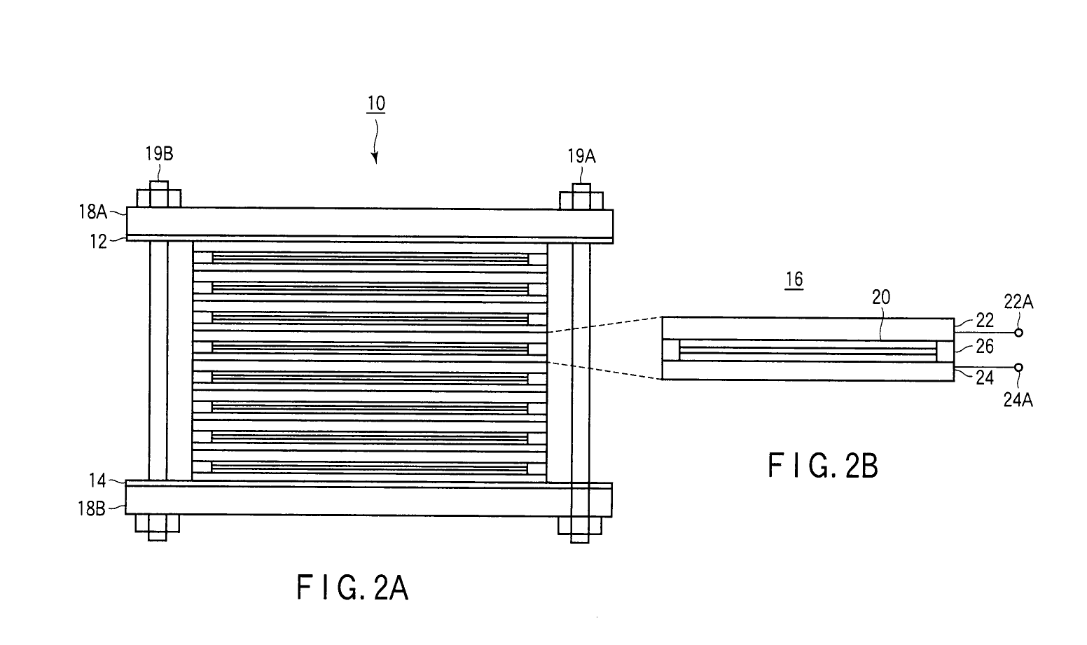

FIG. 1 shows a configuration of a fuel cell system 1 according to a first embodiment of the present invention. The fuel cell system 1 includes a cell stack structure 10 described with reference to FIGS. 2A and 2B. The fuel cell system 1 is composed of a power generation unit 7 generating power, a fuel tank 2 in which a relatively high concentration of fuel containing a mixed solution (a water solution of methanol) of high-concentration methanol as a fuel or a methanol fuel and a small amount of water is stored, and auxiliaries 3 that support power generation in the power generation unit 7.

The auxiliaries 3 are composed of a mixture tank 5 in which a mixed solution of methanol of an optimum concentration for reaction in the power generation unit 7 and water is stored, a fuel supply unit 4 that feeds methanol or a mixed solution of methanol and water to the mixture tank 5, and a fuel circulation unit 6 which feeds the mixed solution of methanol and water in the mixture tank 5 to an anode and which returns an unused solution from the power generation unit 7 to the mixture tank 5. The auxiliaries 3 also includes an air supply unit 11 that supplies air to a cathode in the power generation unit, and a load adjustment unit 8 which provides a load to the power generation unit 7 to detect a current provided to the load and which adjusts the load to control output power from the power generation unit 7. The auxiliaries 3 further includes a cell voltage monitoring unit 32 that senses the cell voltage of each cell in the cell stack, a temperature control unit (temperature adjustment unit) 13 that controls and adjusts the temperature of the power generation unit 3, and a control unit 9 that controls relevant sections in the auxiliaries 3.

The control unit 9 senses required information from the power generation unit 7 and the auxiliaries 3 to process or calculate the sensed information. According to the results of the process or calculation, the control unit 9 generates operation instructions to the fuel supply unit 4, the power generation unit 7, the load adjustment unit 8, and the air supply unit 11. The control unit 9 is composed of a processing unit 9a that controls the auxiliaries 3 and a database 9b in which operation information is stored. The operation information includes the operation instructions provided to the relevant units based on detected information including detection signals detected by the relevant units. As described below, the database 9b includes an abnormal power-difference database 9b-1 referenced to determine whether or not the cell is defective based on a power difference measured in the cell, a crossover conversion database 9b-2 referenced to predict the amount of methanol crossover based on a voltage difference or an average voltage difference (i.e., control parameter or average control parameter)measured in a normal cell, and a supply amount database 9b-3 referenced to determine the amount of fuel based on the predicted amount of methanol crossover.

Here, the fuel amount refers to the product of the concentration of methanol in the fuel and the flow rate of the fuel, that is, the amount of methanol supplied per unit time, the methanol being contained in the fuel (the unit is mol/s).

The temperature control unit 13 includes a temperature sensor (not shown in the drawings). The temperature sensor detects the temperature of the power generation unit 7 to provide a temperature detection signal from the temperature sensor to the control unit 9. Based on the temperature detection signal, the control unit 9 provides a temperature control instruction to the temperature control unit 13 to drive a temperature adjustment element provided in the temperature control unit 13. Thus, the temperature of the power generation unit 7 is maintained within a predetermined range. Preferably, the temperature control unit 13 can individually control the temperatures of cells 16 in the cell stack structure 10. Here, by way of example, the flow rate of cooling air supplied to the individual cells 16 is controlled by the temperature control unit 13 (a fan or the like) to enable adjustment of temperature of each of the cells 16. Furthermore, as described below, the temperature of the cell is controlled, i.e., the cell temperature is raised or lowered so that a cell 16 determined to be defective (hereinafter referred to as a defective cell) can be recovered to a normal state. Thus, by adjusting the flow rate of cooling air supplied to the defective cell, the temperature of the defective cell 16 can be controlled to recover the cell 16 to the normal state.

The power generation unit 7 is connected to a power load 31 via the load adjustment unit 8 and a power adjustment unit 30. Here, the power load 31 corresponds to a power device driven by means of power generated from the fuel cell system 1. The power adjustment unit 30 feeds power generated from the fuel cell system 1 to the power load 31. Here, the power is adjusted by regulating the load. The load is adjusted by the load adjustment unit 8. If the power generated from the power generation unit 7 is lower than the power required for the power load 31, the power adjustment unit 30 compensates for the insufficiency using another power source (for example, a lithium ion battery or a capacitor), though not shown in the drawings. As described below, the power adjustment unit 30 includes a switching circuit that turns on and off a supply of power generated from the fuel cell system 1 to the power adjustment unit 30. In the off state, the power adjustment unit 30 is cut off from the power load 31 so that an output side of the power adjustment unit 30 makes up an open circuit.

A fluid piping system connects the power generation unit 7 to the auxiliaries 3. In the fluid piping system, the fuel tank 2 is connected to the fuel supply unit 4 through a line L1. The fuel supply unit 4 is connected to mixture tank 5 through a fuel supply line L2. Thus, operating the fuel supply unit 4 allows the fuel in the fuel tank 2 to be optionally supplied to the mixture tank 5. Furthermore, in the fluid piping system, the mixture tank 5 is connected to the fuel circulation unit 6 through a fuel supply line L3. The fuel circulation unit 6 is connected to the power generation unit 7 through a supply line L4. The power generation unit 7 and the mixture tank 5 are connected to a fuel supply line L5. Thus, the fuel stored in the mixture tank 5 is supplied to the fuel circulation unit 6 via the fuel supply line L3. The fuel circulation unit 4 feeds the supplied fuel to the power generation unit 7 via the supply line L4. The mixed solution which is not consumed by the power generation unit 7 and carbon dioxide (reaction product) resulting from power generation are separated from each other. Then, the mixed solution is supplied to the line L5, and the carbon dioxide (reaction product) is emitted to the exterior of the power generation unit 7. Furthermore, the mixed solution supplied to the line L5 is returned to the inside of the mixture tank 4. An air supply unit 11 and the power generation unit 7 are connected to a line L6. Air is fed into the cathode in the power generation unit 7.

Additionally, the power generation unit 7 and the auxiliaries 3 are connected through signal and current lines. The control unit 9 is connected to the fuel supply unit 4 through a signal line E1. The power generation unit 7 and the control unit 9 are connected through a signal line E2. The load adjustment unit 8 and the control unit 9 are connected through a signal line E3. The cell voltage monitoring unit and the control unit 9 are connected through a signal line E4. The flow rate of the fuel fed from the fuel supply unit 4 to the mixture tank 5 is measured. Flow rate information containing a measured flow rate signal is transferred to the control unit 9 via the signal line E1. The control unit 9 transfers a flow rate instruction (flow rate setting signal) setting a supply flow rate, to the fuel supply unit 4 via the signal line E1. Thus, the fuel supply unit 4 supplies the fuel to the mixture tank 5 according to the flow rate instruction. Here, the fuel supplied to each cell 16 may be adjusted for the cell 16 using a fuel flow rate adjustment valve (not shown in the drawings) provided in a line for the fuel flowing into the cell 16.

A stack voltage (a whole voltage of the stack cells) generated and output from the cell stack structure (stack structure) 10 in the power generation unit 7 is transferred to the control unit 9 via the signal line E2. The power adjustment unit 30 is connected to the load adjustment unit 8 via the line E7. The load adjustment unit 8 provides a load to the power generation unit 7 via the current line E3. The load adjustment unit 8 detects a load current to generate a load current signal which is transferred to the control unit 9 via the signal line E3 as load current information (load current signal). Furthermore, the control unit 9 generates a load control instruction which is supplied to the load adjustment unit 8 via the signal line E3. Thus, the load adjustment unit 8 connects a load corresponding to a load set according to the load control instruction, to the power generation unit 7. The load current flowing through the set load is then detected and transferred to the control unit 9 as load current information. The power adjustment unit 30 may be omitted, if the load adjustment unit 8 serves as the power adjustment unit 30. In this case, the load power 31 is connected to the load adjustment unit 8.

The cell voltage monitoring unit 32 includes a voltage detection circuit (not shown in the drawings) that detects voltages generated from predetermined unit cells. The cell voltage monitoring unit 32 is connected to the predetermined unit cells in the cell stack structure 10 in the power generation unit 7 via the voltage signal line E4. The cell voltage detection circuit detects voltages generated from the unit cells. The detected cell voltages are transferred to the control unit 9 as cell voltage signals. Here, the predetermined unit cells may includes all the unit cells incorporated in the cell stack structure 10. Alternatively, the combination voltage of a plurality of selected unit cells may be measured. Alternatively, particular cells may be selected as predetermined unit cells. For example, if a large number of unit cells 16 are provided, the cell voltage monitoring unit may select two or three adjacent unit cells to set the combination voltage of the unit cells to be the voltage of the predetermined unit cells instead of detecting the voltages of all the cells.

The power generation unit 7 has the cell stack structure 10 such as the one shown in FIGS. 2A and 2B. The cell stack structure 10 will be described with reference to FIGS. 2A and 2B. In the cell stack structure 10, as shown in FIG. 2A, a plurality of the unit cells 16 are stacked between an anode power collecting plate 12 and a cathode power collecting plate 14. The unit cells 16 are electrically connected in series between the anode power collecting plate 12 and the cathode power collecting plate 14. The unit cells 16 stacked between the anode power collecting plate 12 and the cathode power collecting plate 14 are arranged between paired tightening plates 18A and 18B. The unit cells 16 are tightened and fixed between the tightening plates 18A and 18B by fixtures 19A and 19B. Each of the anode power collecting plate 12 and the cathode power collecting plate 14 is connected to the load adjustment unit 8. A current generated from the cell stack structure 10 is collected by the cathode power colleting plate 14 and supplied to the load adjustment unit.

The unit cell 16 includes a membrane electrode assembly (hereinafter referred to as MEA) 20 as shown in FIG. 2B. An anode channel plate 22 is provided on one side of the membrane electrode assembly 20. A cathode channel plate 24 is provided on the other side of the membrane electrode assembly 20. The membrane electrode assembly 20 is sandwiched between the anode channel plate 22 and the cathode channel plate 24. The membrane electrode assembly 20 is so formed as to be closed by a gasket 26 connected to the anode channel plate 22 and the cathode channel plate 24. The anode channel plate 22 and the cathode channel plate 24 are insulated by the gasket 26. The gasket 26 also prevents the fuel and air from leaking from MEA 20 to the exterior. The membrane electrode assembly 20 includes the anode formed on one side of an electrolytic membrane and the cathode formed on the other side of the electrolytic membrane.

The anode channel plate 22 of each cell 16 is electrically and mechanically connected to the cathode channel plate 24 of the adjacent cell 16. The cathode channel plate 24 of each cell 16 is electrically and mechanically connected to the anode channel plate 22 of the adjacent cell 16. The stacked cells 16 are connected together in series. In each cell 16, output terminals 22A and 24A are provided for the anode channel plate 22 and cathode channel plate 24, respectively, to externally monitor the voltage generated from the cell 16. The output terminals 22A and 24A are connected to the voltage detection circuit in the cell voltage monitoring unit 32 via the cell voltage signal line E4 to monitor the voltage of each cell 16. The cell voltage monitoring unit 32 supplies a voltage signal corresponding to the voltage generated from each cell 16, to the sensing processing unit 9a of the control unit 9 via the signal supply line E4.

The anode channel plate 22 includes a channel through which a water solution of methanol as a fuel flows and which faces the MEA anode side. The water solution of methanol is supplied to MEA via the channel. A gas generated in MEA is discharged via the channel in the anode channel plate 22. The cathode channel plate 24 includes a channel through which air flows and which faces the MEA cathode side. Air is supplied to MEA via the channel. Water generated in MEA 20 and then permeating MEA 20 is discharged via the channel in the cathode channel plate 24.

The membrane electrode assembly (MEA) 20 is formed by applying a catalyst layer to both sides of a solid polymer membrane to form a catalyst layer and joining a gas diffusion layer to the outside of the catalyst layer to allow power collection, fuel supply, and discharge of reaction products to be smoothly performed. An ion-exchange membrane made of Nafion (Trade mark) manufactured by Dupont may be used as a solid polymer membrane. A commercially available Pt—Ru catalyst, a commercially available Pt catalyst, and the like may be used as an anode catalyst layer and a cathode catalyst layer. Commercially available carbon paper, commercially available carbon fibers, or a commercially available carbon non-woven cloth may be used as a gas diffusion layer. A micro porous layer made up of carbon and a material having water-repelling characteristics.

The anode channel plate 22 is provided in order to supply the fuel to and discharge the product from the anode in the membrane electrode assembly 20. The cathode channel plate 24 is provided in order to supply air to and discharge the product from the cathode in the membrane electrode assembly 20. Furthermore, both the anode channel plate 22 and the cathode channel plate 24 are provided in order to collect electric power generated by the reaction. The anode channel plate 22 and the cathode channel plate 24 may have any shape. For example, a serpentine channel plate may be used as the anode channel plate 22.

Now, operation of the fuel cell system shown in FIG. 1 will be described.

Before starting power generation, the fuel circulating unit 6 is operated to supply a water solution of methanol of a predetermined concentration accumulated in the mixture tank 5, to the anode channel plate 22 via the line L4. The air supply unit 11 is operated to supply air to the cathode channel plate 24 via the channel L6. Thus, on the anode side of the anode channel plate 22, the fuel permeates MEA 20 from the channel through which the fuel flows, to the anode. On the cathode side of the cathode channel plate 24, air permeates MEA 20 from the channel through which the air flows, to the cathode.

The load adjustment unit 8 is operated to apply the load to be connected to the cell stack structure 10. Then, methanol oxidation reaction expressed by Formula (1) occurs in the anode catalyst layer, that is, on the anode side of MEA 20. Oxidation-reduction reaction expressed by Formula (2) occurs in the cathode catalyst layer, that is, on the cathode side of MEA 20.

Protons (H+) generated by the anode catalyst flows from the anode catalyst layer to the cathode catalyst layer through the solid polymer membrane. At this time, simultaneously with the flow of the protons, methanol flows to the cathode catalyst layer through the solid polymer membrane. Then, on the cathode side, reaction expressed by Formula (3) occurs to consume methanol (methanol crossover). Electrons (e−) flow through the load adjustment unit 8. Carbon dioxide (CO2) generated in the anode catalyst layer is emitted to the exterior of the power generation cell stack structure 10 via the channel in the anode channel plate 22. Here, to discharge carbon dioxide from the fuel cell system 1, a gas-liquid separation mechanism is provided in the mixture tank 5, the line L5, or the power generation cell stack structure 10. Part of the water solution of methanol which has failed to react in the power generation cell stack structure 10 is returned to the mixture tank 5 again through the fuel supply line L5.

Continuing the power generation causes the methanol to be consumed by the oxidation reaction in Formula (1) and the methanol crossover in Formula (3). Thus, the concentration of the methanol in the mixture tank 5 decreases. The decrease in methanol concentration reduces the methanol crossover to increase fuel utilization efficiency. On the other hand, if the concentration decreases below a predetermined lower limit value, the reaction rate of the methanol oxidation reaction in Formula (1) decreases to reduce the output. Thus, power generation efficiency decreases. Then, the control unit 9 operates the fuel supply unit 4 to carry out a process of feeding the methanol from the fuel tank 2 to increase the methanol concentration and thus the amount of fuel. However, if the methanol concentration increases above a predetermined upper limit value, the amount of methanol crossover increases to reduce the fuel utilization efficiency. Thus, the control unit 9 controls the concentration of the fuel in the mixture tank 5 so as to limit the amount of methanol crossover within a predetermined range. The control unit 9 thus controls the fuel cell system so as to improve both the fuel utilization efficiency and the power utilization efficiency. Here, the fuel utilization efficiency is defined as the ratio of the reaction in Formula (1) to the methanol crossover in Formula (3) “the amount of reaction in Formula (1)/(the amount of the reaction in Formula (1)+the amount of the methanol crossover in Formula (3))”. The power generation efficiency is defined as “cell voltage/theoretical voltage×fuel utilization efficiency”.

Thus, in an embodiment of the present invention, the amount of methanol crossover is predicted by a technique described below. To limit the predicted crossover within a predetermined range, the control unit 9 operates the fuel supply unit 4 to control the concentration of the methanol in the mixture tank 5. (Method of predicting the amount of methanol crossover)

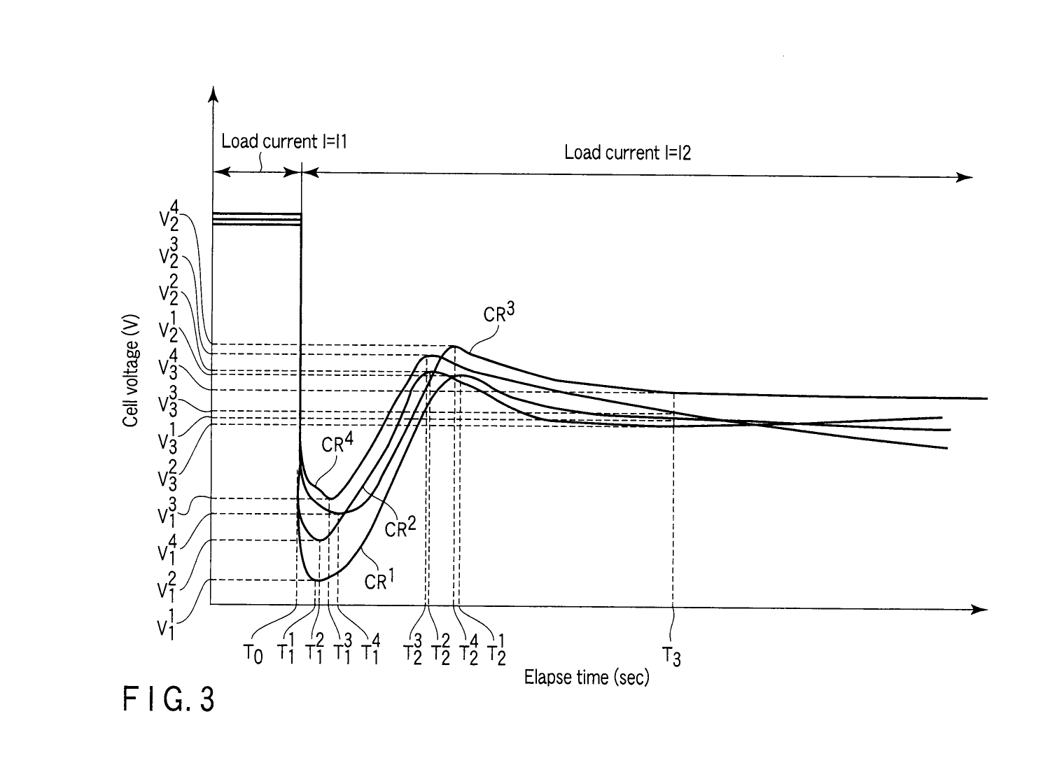

FIG. 3 shows reaction characteristics CR¹, CR², CR³, and CR⁴ of cell voltages output from the cells 16 when the load adjustment unit 8 switches the load to change a load current I extracted from the cell stack structure 10 step by step from a load current I1 to a load current I2. Reference characters CR¹, CR², CR³, and CR⁴ denote the characteristics of the cell voltages measured in four cells 16¹ to 16⁴ in the cell stack structure 10 in which the cells 16¹ to 16⁴ are stacked. The cells 16¹ to 16⁴ are connected to the cell voltage monitoring unit 32, which individually monitors the voltages of the cells 16¹ to 16⁴ and supplies cell voltage signals to the sensing processing unit 9a.

In FIG. 3, upper suffixes 1 to 4 denote the cell numbers 1 to 4 of the four cells 16. Lower suffix “1” corresponds to a minimum voltage value V₁ (minimum point voltage value) and a point in time T₁ when the cell voltage exhibits the minimum voltage value V₁. Lower suffix “2” corresponds to a maximum voltage value that is an output response value appearing after the minimum voltage and a point in time T₂ when the cell voltage exhibits the maximum voltage value. Lower suffix “3” corresponds to a steady-state voltage V₃ that is an output response value appearing after the minimum voltage and a point in time T₃ when the cell voltage exhibits the value of the steady-state voltage V₃.

In the graph shown in FIG. 3, in a time period before a point in time T=T₀, the load adjustment unit 8 selects the first load to extract a load current I=I1 from the cell stack structure 10. At a point in time T=T0, the load adjustment unit 8 changes the first load to the second load to increase the load current I step by step from I=I1 to I=I2. In conjunction with this variation in load current I, at a point in time T=T₁ⁿ immediately after the switching to the second load, the cell voltage V of the nth (n is 1 to 4) cell exhibits the minimum voltage value (minimum point voltage value) at V=V₁ⁿ, thereafter reaches the maximum voltage value (V₂ⁿ), and converges gradually to a substantial given value (steady-state voltage V₂ⁿ). Here, a voltage difference ΔV₂ⁿ (ΔV₂ⁿ=V₂ⁿ−V₁ⁿ) occurs between the minimum voltage value V₁ⁿ and the maximum voltage value V₂ⁿ. A voltage difference ΔV₃ⁿ (ΔV₃ⁿ=V₃ⁿ−V₁ⁿ) occurs between the minimum voltage value V₁ⁿ and the steady-state voltage V₃ⁿ, obtained a given time (for example, T=T3) later. The voltage differences ΔV₂ⁿ and ΔV₃ⁿ are employed as evaluation values, i.e., control parameters for each cell 16ₙ. Each cell 16ₙ is evaluated based on the evaluation values (the control parameters) as described below.

One of the first and second loads has a zero load value, and the other has a predetermined value.

In the description below, a point in time T₁ⁿ is defined as time when the nth cell 16ⁿ exhibits the minimum voltage value V₁ⁿ immediately after a load change. A point in time T₂ⁿ is defined as time when the nth cell 16ⁿ exhibits the first maximum voltage value V₂ⁿ immediately after the load change. A point in time T₃ is defined as time when the cell voltage changes to the steady-state voltage V₃ⁿ after all the cells 16¹ to 16ⁿ have reached the first minimum voltage value V₁ⁿ and the maximum voltage value V₂ⁿ. The point in time T3 may be set to any point in time after all the n cells have reached the first minimum voltage value (V₁ⁿ) and the first maximum voltage value (maximum voltage value V₂ⁿ). Here, experiment results indicate that even with a variation among the cells 16ⁿ, the point in time T₁ⁿ tends to be observed within 10 seconds after the load change. Thus, for example, the point in time T3 can be defined to be 10 to 60 seconds after the load change.

If all the cells are placed under the same conditions and in the same environment, for example, all the cells operate at the same fuel flow rate, the same air flow rate, and the same temperature, a relationship between the methanol crossover and a stack voltage difference ΔV₂ⁿ can be approximated to a generally unique linear relationship as described in JP-A2008-011863 (KOKAI); the stack voltage difference ΔV₂ⁿ corresponds to the voltage difference between the minimum voltage (minimum voltage value) output from the cell stack structure 10 and the maximum voltage value that is an output response value following the minimum voltage. Furthermore, a relationship between the voltage difference ΔV₃ⁿ and the methanol crossover can be approximated to a generally unique linear relationship.

However, if a specific error (defect) occurs such as a biased air or fuel distribution flow to a particular cell 16 (hereinafter simply referred to as a defect in the cell), the unique linear relationship fails to be established between both the voltage differences ΔV₂ⁿ and ΔV₃ⁿ and the amount of methanol crossover. Then, the amount of methanol crossover cannot be predicted.

Description will be given of the basic principle of a process in which the cell voltage monitoring unit 32 monitors the cell voltage, and the sensing processing unit 9a determines the voltage difference ΔV₂ⁿ between the minimum voltage value V₁ⁿ and the maximum voltage value V₂ⁿ corresponding to the output response value appearing after the minimum voltage so that the amount of methanol crossover can be predicted based on the voltage difference ΔV₂ⁿ.

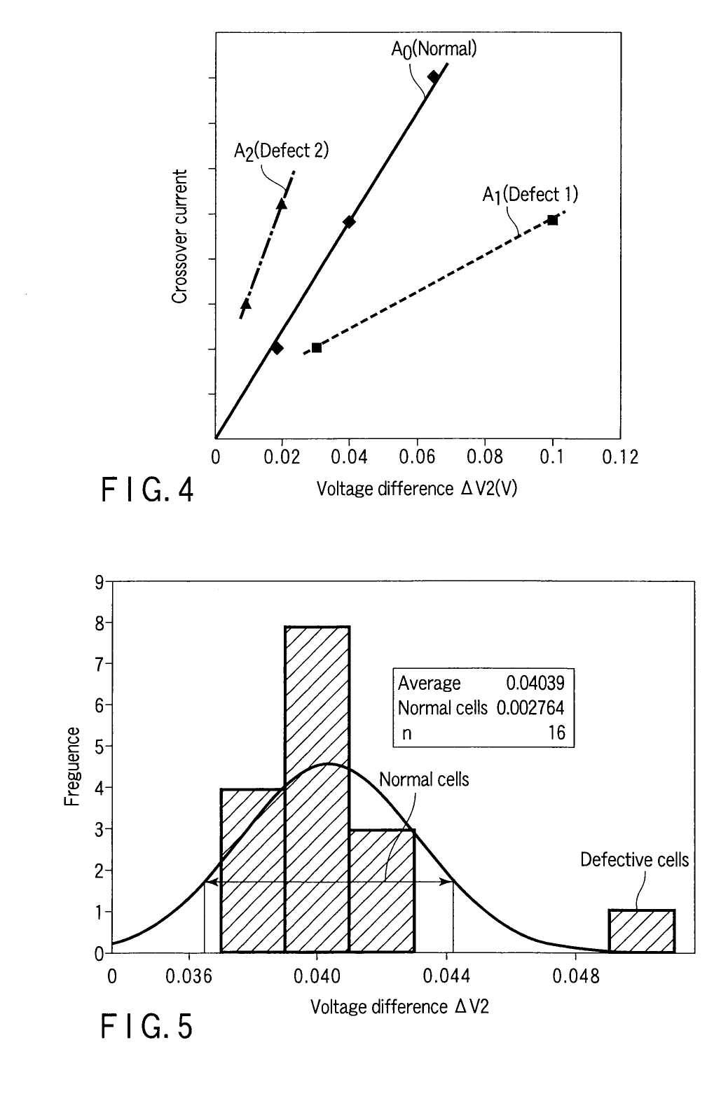

FIG. 4 is a graph showing a relationship between a methanol crossover current resulting from the amount of methanol crossover, which is a measurement result, and the voltage differences ΔV₂ⁿ. Here, the methanol crossover current was determined by measuring the amount of CO₂ generated by the methanol crossover reaction in Formula (3).

In a normal state in which the amounts of fuel and air are sufficient, the characteristics of the methanol crossover current and the voltage difference ΔV₂ⁿ are such that the voltage differences ΔV₂ⁿ and the methanol crossover current have a certain given linear relationship as shown by a line A0. However, if the air distribution flow fails to be uniformly distributed to the cells 16 and thus varies to non-uniformly supply air to the cells 16, resulting in air shortage in some cells, or the cathode is flooded in some cells, or a part of the cathode channel is closed in some cells, then the system suffers oxygen shortage. Here, the flooding refers to a phenomenon in which water generated by the reaction in Formula (2) fails to be discharged from the membrane electrode assembly 20 and is stored inside the assembly 20 to hinder the air supply. Thus, even if such an amount of fuel as limits the crossover within the predetermined range is supplied to successfully limit the amount of crossover within the predetermined range, the value of the voltage difference ΔV may increase (this is referred to as a cell defect 1). When the voltage difference ΔV is sensed to predict the amount of methanol crossover, in the state of the cell defect 1, the voltage difference ΔV2 is larger than the amount of methanol crossover in a standard cell as shown by a line A1. Thus, even when the amount of methanol crossover in the cell defect 1 is actually the same as that in the standard cell, the cell defect 1 is predicted to undergo high methanol crossover. Consequently, when the control unit 9 operates the fuel circulation unit 6 based on the predicted amount of crossover to determine the amount of methanol to be fed into the mixture tank, the concentration of methanol currently supplied to the cell stack structure 10 is determined to be higher than the actual value. This prevents the concentration of the fuel in the mixture tank 5 from being accurately controlled. On the other hand, local fuel shortage may occur in the cells 16 to which an insufficient amount of fuel is supplied owing to a variation in fuel distribution flow or in which a part of the anode channel is closed. Thus, even if such an amount of fuel as limits the crossover within the predetermined range is supplied to successfully limit the amount of crossover within the predetermined range, the voltage difference may decrease (this is referred to as a cell defect 2). When the voltage difference ΔV2 is sensed to predict the amount of methanol crossover, in the state of the defect 2, the voltage difference ΔV2 is smaller than the amount of methanol crossover in the standard cell as shown by a line A2. Thus, even when the amount of methanol crossover in the cell defect 2 is the same as an initially set value, the cell defect 2 is predicted to undergo low methanol crossover. This prevents the concentration of the fuel in the mixture tank 5 from being accurately controlled, as is the case with the defect 2.

Thus, for the stack structure 10 composed of a plurality of cells, the accuracy with which the amount of crossover is predicted can be improved by excluding information (voltage signals) on the cells suffering the defects A1 and A2 in predicting the amount of crossover. That is, in predicting the amount of crossover, the sensing processing unit 9a excludes information (cell voltage signals) on the cells suffering the defects 1 and 2, based on a principle described below.

FIG. 5 shows an example of a histogram of the voltage difference ΔV₂ⁿ in each cell 16 in the cell stack structure 10 in which 16 cells are stacked (N=16). The cell voltage monitoring unit 32 detects the voltages of all the 16 cells as unit cells. It is assumed that in the cell stack structure 10, the fuel circulation unit 16 supplies a water solution of methanol of the same concentration to each cell 16. The average voltage difference over the 16 cells, expressed by Formula (4), is about 0.040 V.

$$Δ {V}_{2}^{ave} = {\sum }_{n = 1}^{n = 16} Δ {V}_{2}^{n} / N \qquad ( 4 )$$

However, in FIG. 5, the voltage difference in one cell shown as a defective cell by an arrow is larger than those in the other cells. Here, the number of defective cells is assumed to be M. In the histogram shown in FIG. 5, M=1. The defective cells each exhibit a voltage difference different from that in the other cells, though a fuel of the same concentration is supplied to all the cells. The sensing processing unit 9a determines that processing the output voltage signals from the defective cells may result in an error in the prediction of the amount of crossover. The sensing processing unit 9a then determines the voltage difference in all the cells other than the defective ones; the cells other than the defective ones are expressed by Formula (5).

$$Δ {V}_{2}^{{ave}^{′}} = {\sum }_{n = 1}^{n - m} Δ {V}_{2}^{n} / ( N - M ) = 0.039 V \qquad ( 5 )$$

Estimating the amount of crossover based on ΔV₂^{ave′} enables the crossover prediction accuracy to be improved. Whether or not the cell is defective is determined by determining the frequency distribution S(ΔV₂ⁿ) of the voltage differences ΔV₂ⁿ in the cells and determining a cell with a voltage difference deviating from a predetermined range corresponding to the frequency distribution to be defective. More specifically, the voltage difference ΔV₂ⁿ falling within the range of standard deviations corresponding to the frequency distribution is considered to have been determined from the output signal from a normal cell. The voltage difference ΔV₂ⁿ falling outside the range of standard deviations corresponding to the frequency distribution is considered to have been determined from the output signal from a defective cell. Then, the defective cells are excluded from the prediction of the amount of crossover. A Gaussian distribution can be used as the frequency distribution.

In the above description, the amount of crossover is predicted by using the average (average control parameter) of the evaluation values, i.e., the control parameters of the cells determined to be normal. However, obviously, the amount of crossover may be predicted by, instead of using the average voltage difference (average control parameter), using voltage differences determined for only particular cells selected from the group of normal cells.

Furthermore, if the cell stack structure 10 is composed of a large number of unit cells 16, detecting the voltage differences ΔV₂ⁿ in all the cells as described in the above-described technique may increase the costs of the detection system or complicate the processing method. Thus, some particular unit cells 16 may be extracted so that the voltage differences ΔV₂ⁿ in the extracted particular unit cells can be used as control parameters, for example, the sum of the voltage differences ΔV₂ⁿ in a plurality of unit cells may be used.

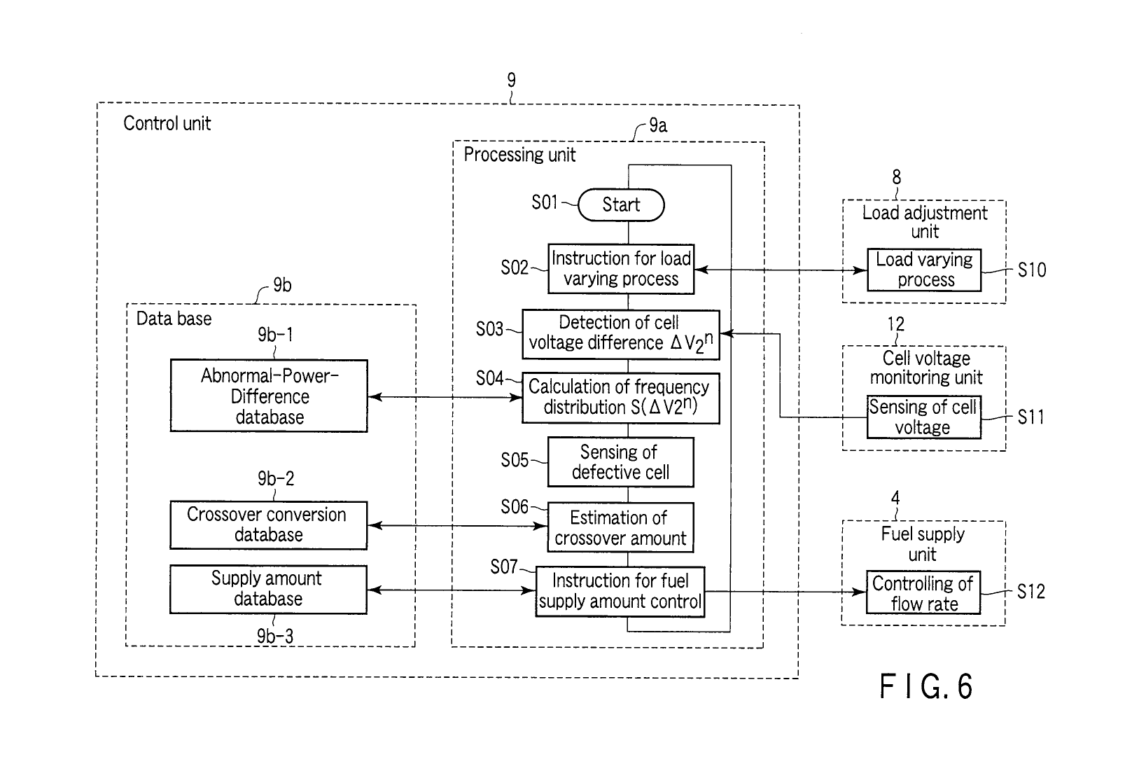

FIG. 6 shows, in detail, a control operation performed in the control unit 9 based on signals output from the load adjustment unit 8, the cell voltage monitoring unit 32, and the fuel supply unit 4. The control operation performed in the control unit 9 will be described with reference to FIG. 6.

The control operation is started as shown in step S01. Then, as shown in step S02, the processing unit 9a in the control unit 9 provides an instruction for a load varying process to the load adjustment unit 8. Upon receiving the instruction, the load adjustment unit 8 executes a load varying process to change the load connected to the power generation unit 7 as shown in step S10. At the same time when the load adjustment unit 8 changes the load, the cell voltage monitoring unit 32 allows the voltage detection circuit in the cell voltage monitoring unit to measure the cell voltage of the cell 16 as shown in step S11. Thus, a cell voltage signal output from each cell 16 and varying over time is input to the sensing processing unit 9a in the control unit 9 from the cell voltage monitoring unit 32 as shown in step S03. The difference between the minimum voltage value and maximum voltage value contained in the voltage signal is determined to be the voltage difference ΔV₂ⁿ.

Then, the processing unit 9a calculates the frequency distribution S(ΔV₂ⁿ) of the voltage differences ΔV₂ⁿ as shown in step S04. A predetermined frequency distribution in the abnormal-power-difference database 9b-1 in the database 9b is compared with the frequency distribution S(ΔV₂ⁿ) of the voltage differences ΔV₂ⁿ to sense defective cells as shown in step S05. That is, the cells 16 with a voltage difference ΔV₂ⁿ falling within a predetermined frequency distribution in the database 9b-1, for example, the range of standard deviations, are determined to be normal. The cells 16 with a voltage difference ΔV₂ⁿ falling outside a predetermined range, for example, the range of standard deviations are determined to be defective. The cells 16 are thus classified into a group of the normal cells and a group of the defective cells. Then, the average of the voltage differences ΔV₂ⁿ only in the group of the normal cells 16 is determined and set to be an evaluation voltage difference (i.e., control parameter) ΔV₂′. The crossover conversion database is referenced using the evaluation voltage difference ΔV₂′, to predict the amount of methanol crossover, as shown in step S06. The crossover supply amount control database 9b-3 is referenced using the predicted amount of crossover. Then, according to the relationship between the crossover and the fuel supply amount, the processing unit 9a generates a flow rate instruction to the fuel supply unit 4 to supply a set amount of fuel, as shown in step S07. Upon receiving the instruction, the fuel supply unit 4 controls the fuel supply unit 4 so as to set the fuel supply amount to be equal to a predetermined flow rate as shown in step S12. Controlling the fuel supply unit 4 allows the concentration of the fuel in the mixture tank 5 to be controlled. As a result, the amount of crossover provided to the power generation unit 7 is predicted. The fuel concentration is thus controlled so as to limit the amount of crossover within the predetermined range. That is, the fuel amount is controlled.

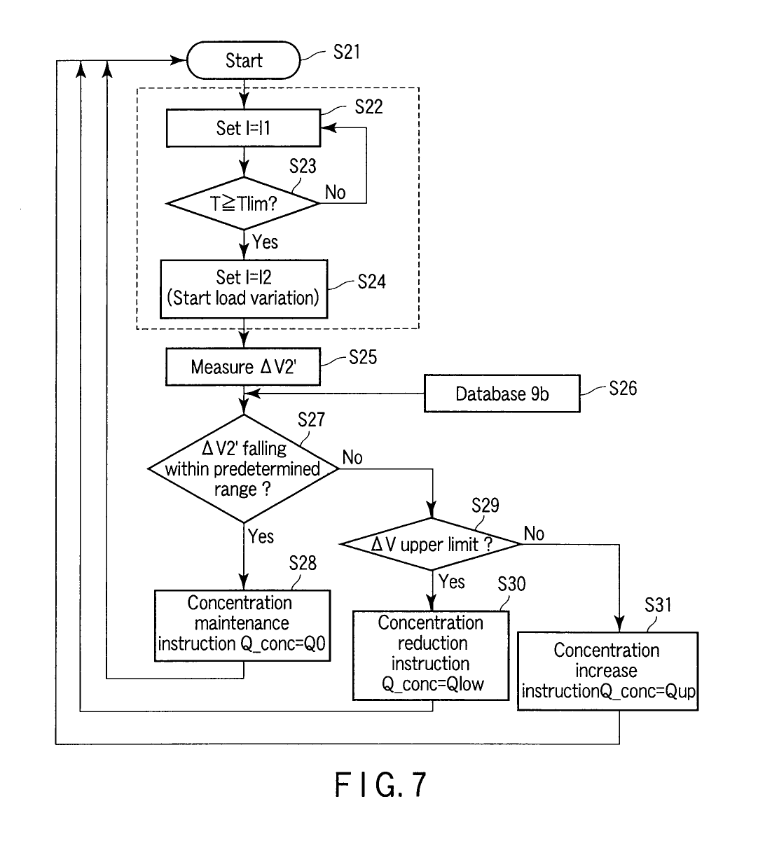

Now, with reference to FIG. 7, description will be given of a control flow in which the flow rate of fuel fed from the fuel tank 2 is controlled so as to limit the amount of crossover within the predetermined range in order to limit the power generation efficiency within the predetermined range.

FIG. 7 shows a flowchart of control based on a response of the cell voltage generated due to the changing of the load in the system.

The system flowchart is pre-stored in the database 9b in the control unit 9 so that the auxiliaries are operated and controlled based on relevant conditions.

Control for limiting the power generation efficiency within the predetermined range is started as shown in step S21. First, a timer (not shown in the drawings) is set, and as shown in step S22, the load current flowing through the load is set to I1. Then, as shown in step S23, the control unit 9 checks whether or not a time interval Tlim preset during system operation has elapsed. If the time measured by the timer is shorter than the time interval Tlim, the process is returned to step S22 to wait until the time interval Tlim elapses. Once the time interval Tlim elapses, the load adjustment unit 8 is operated to switch the first load to the second load, and the load change in each of the cells 16 in the cell stack structure 10 is measured, as shown in step S24. A program is set in the sensing processing unit 9a so as to periodically cause the load change at equal time intervals Tlim during operation of the fuel cell. The concentration of fuel supplied to the power generation unit 7 is periodically predicted and thus controlled. The periodic prediction and control of the fuel concentration enables the system to operate at high power generation efficiency for a long time. In a load varying process, a current of a predetermined value I1 is set to flow through the load, which is this held for a given time until the voltage value becomes stable operation. The current value is thereafter changed to I2. The value of a response from each of the cells in the cell stack structure 10 after the change to the current I2 is then monitored. As shown in step S25, the evaluation voltage difference ΔV2′ is measured, and as shown in step S26, the database 9b-3 is referenced.

In step S27, the evaluation voltage difference ΔV2′ is compared with the predetermined range stored in the database 9b. In step S27, if the evaluation voltage difference ΔV2′ falls within a predetermined range, the crossover over-voltage lies within the predetermined range. Consequently, the control unit 9 determines that the concentration of the fuel supplied to the power generation unit 7 falls within the predetermined range. Thus, as shown in FIG. 28, the fuel supply unit 4 is operated so as to set the amount Q of fuel fed from the fuel tank 2 to be equal to a preset give flow rate (Q=Q0). In this case, to determine whether or not the evaluation voltage difference ΔV2′ falls within the predetermined range, the control unit 9 makes the determination based on a conversion table for the evaluation voltage difference ΔV2′ and concentration stored in the database 9b-3. Conditions for the fuel supply flow rate Q0 are also stored in the database 9b-3.

On the other hand, in step S27, if the evaluation voltage difference ΔV2′ falls outside the predetermined range, the control unit 9 determines whether or not the evaluation voltage difference ΔV2′ is above the predetermined range (whether or not the evaluation voltage difference ΔV2′ is an upper limit) as shown in step S29. If the evaluation voltage difference ΔV2′ is above the predetermined range, the crossover over-voltage of each of the cells 16 in the cell stack structure 10 is too high. Thus, as shown in step S30, the amount Q of fuel fed from the fuel tank 2 is reduced, and the fuel supply unit 4 is operated such that the fuel supply amount Q=Qlow<Q0. The process is returned to step S21, and the given time interval Tlim later, a load change is caused again. Then, in step S25, the evaluation voltage difference ΔV2′ is measured. If in step S27, the evaluation voltage difference ΔV2′ gradually falls within the predetermined range, then as shown in step S28, the fuel supply unit 4 is operated so as to change the fuel supply amount Q=Qlow to Q0, and the operation is continued. If even the given time interval Tlim later, the evaluation voltage difference ΔV2′ remains above the predetermined range, the operation is continued with the fuel supply amount Q=Qlow reduced as shown in step S30.

If in step S27, the voltage difference ΔV2′ falls outside the predetermined range and in step S29, the evaluation voltage difference ΔV2′ is below the predetermined range, the crossover over-voltage of each of the cells 16 in the cell stack structure 10 is reduced. Continuing the operation in this condition may result in the shortage of supplied fuel. Consequently, as shown in step S31, the amount of fuel fed from the fuel tank 2 is increased, and the fuel supply unit 4 is operated such that Q=Qup>Q0. The process is returned to step S21 again, and the given time interval Tlim later, a load change is caused. In step S25, the voltage difference ΔV2′ is measured. If in step S27, the evaluation voltage difference ΔV2′ falls within the predetermined range, the fuel supply unit 4 is operated so as to change the fuel supply amount Q=Qup to Q0, and the operation is continued according to the flowchart. If even the given time interval Tlim later, the evaluation voltage difference ΔV2′ remains below the predetermined range in step S27, the operation is continued with the increased fuel supply amount Q=Qup maintained as shown in step S31.

As described above, the system according to the embodiment can measure the evaluation voltage difference ΔV2′, which correlates with the crossover over-voltage of the power generation unit 7, to control the fuel supply amount according to the information on the measured evaluation voltage difference ΔV2′. The control of the fuel supply amount based on the measured voltage difference information enables more accurate control than a technique of using a concentration sensor to sense the concentration of the fuel in the mixture tank 5 and predicting the crossover over-voltage based on the sensed concentration state to control the fuel supply. For example, if the cell stack structure 10 is operated over a long term, the amount of fuel introduced into the cell stack structure 10 may disadvantageously be varied by, for example, aging degradation of the membrane electrode assembly. If the fuel introduction amount varies, the concentration of the fuel supplied to the power generation unit 7 needs to be temporally varied depending on the amount of introduced fuel in order to maintain the crossover over-voltage constant to allow the operation to be continued with the power generation efficiency kept within the predetermined range. However, the system according to the embodiment of the present invention eliminates the need to predict the crossover over-voltage based on the information on the concentration of the fuel in the mixture tank 5. The system utilizes the value of the crossover over-voltage directly as measurement information. This allows easy dealing with such temporal changes. Furthermore, the system eliminates the need for a special component such as a concentration sensor and can thus be made compact and inexpensive.

Additionally, the system according to the embodiment, the evaluation voltage difference ΔV2′ is determined from responses during a non-steady state in which disturbance is applied to the system. This enables a reduction in time required for the measurement compared to the case in which the voltage value in the steady state is used. Furthermore, in the system shown in FIG. 1, if the concentration D of the water solution of methanol stored in the mixture tank 5 is higher than the preset concentration of the water solution, the amount of crossover and thus the evaluation voltage difference ΔV2′ are large. On the other hand, if the concentration D of the water solution of methanol stored in the mixture tank 5 is lower than the preset concentration of the water solution, the amount of crossover and thus the evaluation voltage difference ΔV2′ are small. Since the evaluation voltage difference ΔV2′ is determined based only on the voltage signals from the normal cells determined to be normal with the defective cells excluded based on the frequency distribution, the amount of crossover can be more accurately calculated. Therefore, the power generation efficiency can be more accurately controlled.

### Second Embodiment

The control method according to the first embodiment shown in FIG. 6 senses the defective cells and predicts the amount of crossover using the voltage differences only in the normal cells. In addition to this control method, control may be performed such that the system determines what defect is occurring in the defective cell based on the state of the voltage difference in the defective cell and then recovers the defective cell to the normal state. The process of recovering the defective cell to the normal state may be carried out during the above-described periodic process of controlling the fuel supply amount according to the evaluation voltage difference ΔV2′. The defective cells detected in step S05 of the process of controlling the fuel supply amount, shown in FIG. 6, are to be recovered to the normal state.

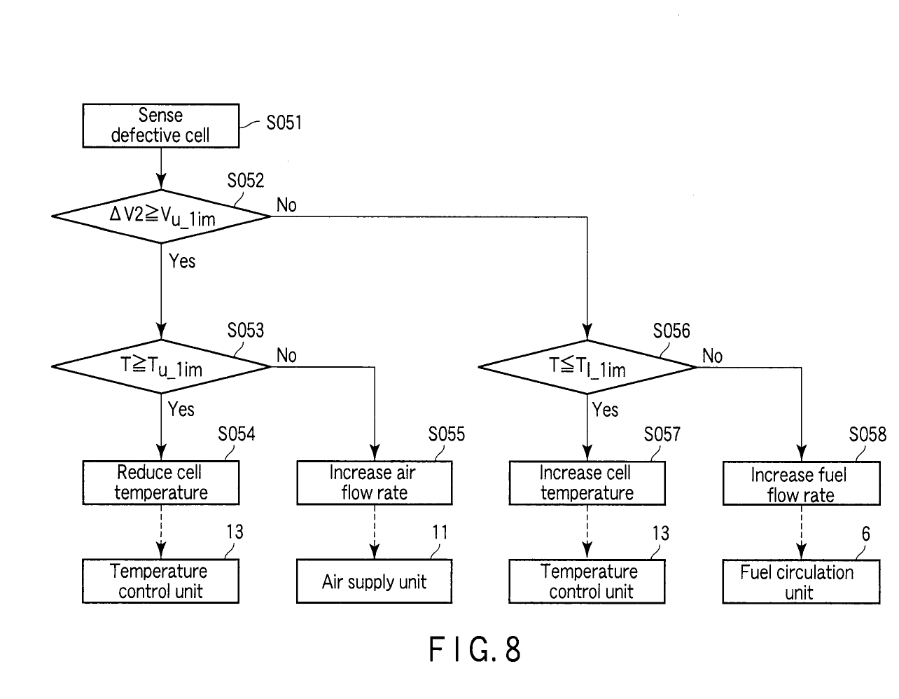

FIG. 8 is a detailed flowchart showing the process of recovering the defective cells in the system. The recovery of the defective cells will be described with reference to FIG. 8.

The control operation based on the flowchart is pre-recorded in the database 9b in the control unit 9. The auxiliaries are operated and controlled by the control unit 9 based on relevant conditions.

As shown in step S051, the control unit 9 determines whether or not the measured voltage difference ΔV₂ⁿ in the cell determined to be defective is greater than a predetermined voltage upper limit value. Then, if in step S052, the voltage difference ΔV₂ⁿ is greater than the predetermined value (YES), then the control unit 9 determines whether or not the temperature of the power generation unit 7 is higher than a predetermined value as shown in step S053. Here, the temperature of the power generation unit 7 is detected by a temperature sensor (not shown in the drawings) in the temperature control unit 13, provided in the power generation unit 7. A temperature signal from the temperature sensor is transmitted to the control unit 9 via the signal supply line E5. In step S503, if the temperature of the power generation unit 7 is higher than the predetermined upper limit value (YES), the control unit 9 determines the error in voltage difference ΔV₂ⁿ to be caused by the temperature of the power generation unit higher than the predetermined value. In step S054, the control unit provides a temperature reduction instruction to the temperature control unit to execute a process of reducing the temperature of the power generation unit 7.

If in step S052, the voltage difference ΔV₂ⁿ is greater than the predetermined voltage upper limit value, and in step S053, the temperature of the power generation unit 7 is lower than the predetermined upper limit value, then the control unit 9 determines the error in voltage difference ΔV₂ⁿ to be caused by air shortage. Then, in step S055, the control unit 9 provides an air flow rate increase instruction to the air supply unit 11 to execute a process of increasing the flow rate of air supplied to the cell.

If in step S52, the voltage difference ΔV₂ⁿ in the cell determined to be defective is equal to or smaller than the predetermined voltage upper limit value, then in step S056, control unit 9 determines whether or not the temperature of the power generation unit 7 is lower than a predetermined value. If the temperature of the power generation unit 7 is lower than the lower limit value, then the control unit 9 determines the error in voltage difference ΔV₂ⁿ to be caused by the temperature of the power generation unit 7 lower than the predetermined value. Then, in step S057, the control unit 9 provides a temperature increase instruction to the temperature control unit 13 to execute a process of increasing the temperature of the power generation unit 7.

In step S054 or S057, if the temperatures of the cells 16 in the power generation unit 7 are individually controllable, the defective cells are controlled such that the temperature of each the defective cells 16 is reduced or increased. If the power generation unit 7 is not configured to be able to individually control the temperatures of the cells 16 in the power generation unit 7, the temperature of the cell stack structure 10 including the defective cells 16 may be reduced or increased.

If in step S052, the voltage difference ΔV₂ⁿ in the cell determined to be defective is equal to or smaller than the predetermined voltage upper limit value, and in step S056, the temperature of the power generation unit 7 is higher than the predetermined lower limit value, then the control unit 9 determines the error in voltage difference ΔV₂ⁿ to be caused by fuel shortage. Then, in step S058, the control unit 9 provides a fuel flow rate increase instruction to the fuel circulation unit 6 to execute a process of increasing the flow rate of the fuel supplied to the cell.

If at least two cells are determined to be defective, and the voltage difference in one of the defective cells is greater than the predetermined upper limit value, whereas the voltage difference in the other defective cell is smaller than the predetermined lower limit value, then the operations in steps S055 and S058 or a plurality of steps S054, S055, S057, and S058 may be simultaneously executed.

In steps S054, S055, S057, and S058, the operation of the auxiliaries may be continued for a given duration after detection of a defect. The duration may be optionally set. The process shown in FIG. 8 enables the defective cells to be recovered, thus allowing the power generation efficiency to be improved. The process further reduces the number of defective cells, allowing improvement of the accuracy with which the amount of crossover is predicted as well as the fuel utilization efficiency.

### Third Embodiment

A third embodiment relates to a control method of controlling a fuel cell system that supplies the fuel in the fuel tank 5 directly to the cell stack structure 10.

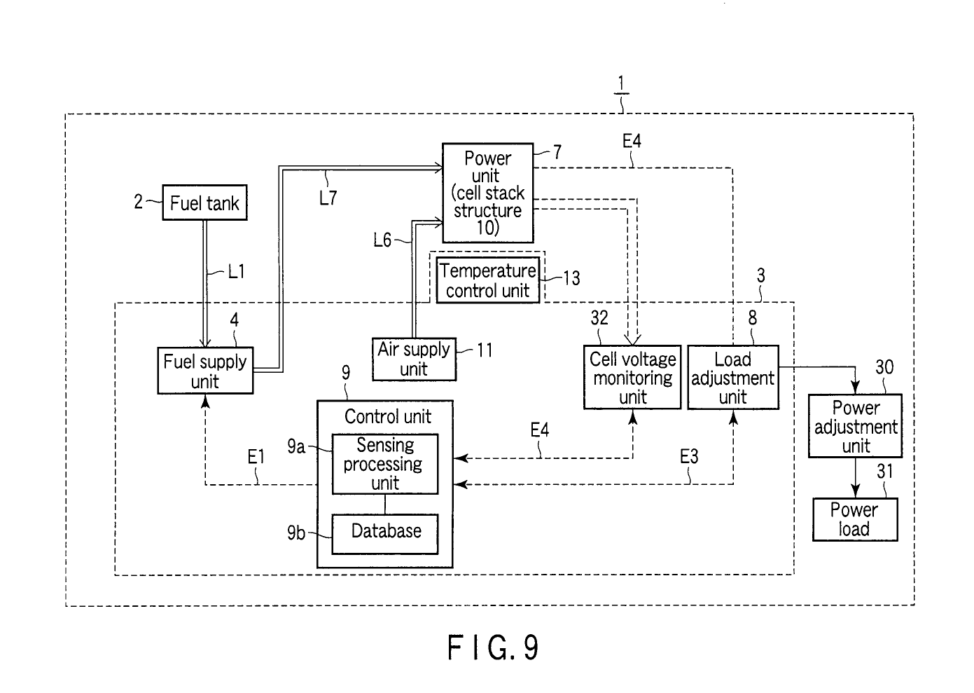

FIG. 9 shows a configuration of a fuel cell system according to the third embodiment. In FIG. 9, the same reference numerals as those shown in FIG. 1 denote the same sections and components as those shown in FIG. 1. These sections and components will thus not be described.

The system 1 shown in FIG. 9 is composed of the cell stack structure 10 including electrodes, the fuel tank 2 containing the fuel or a mixed solution of the fuel and water, and auxiliaries 3 that support the power generation unit 7.

The power generation unit 7 is connected to the power load 31 via the load adjustment unit 8 and the power adjustment unit 30. Here, the power load 31 corresponds to the power device driven by means of power generated from the fuel cell system 1. The power adjustment unit 30 feeds power generated from the fuel cell system 1 to the power load 31. As described below, the power adjustment unit 30 includes the switching circuit that turns on and off the supply of power generated from the fuel cell system 1 to the power adjustment unit 30. In the off state, the power adjustment unit 30 is cut off from the power load 31 so that the output side of the power adjustment unit 30 makes up an open circuit.

The auxiliaries 3 are composed of the fuel supply unit 4 that feeds methanol or a mixed solution of methanol and water from the fuel tank 2 to the power generation cell stack structure 10, the load adjustment unit 8 that senses the power value of the power generation unit 7 to extract the load from the power generation unit 7, the air supply unit 11 that supplies air to the cathode of the power generation unit 7, the cell voltage monitoring unit 32 that senses the voltage of each of the cells in the cell stack structure 10, the temperature control unit 13 that controls the temperature of the power generation unit, and the control unit 9 that senses required information from the power generation unit 7 and the auxiliaries 3 to provide control instructions to the auxiliaries. Here, for example, a liquid flow rate control pump may be used as the fuel supply unit 4. Furthermore, for example, an air flow rate control pump or a fan may be used as the air supply unit. If the fan is used as the air supply unit 11, the same fan can be used to cool the temperature control unit 13 and to supply air for power generation. The cell voltage monitoring unit 32 can not only sense the voltages of all the cells in the cell stack but also sense the cell voltage of a particular cell or sense the total of the cell voltages of a plurality of cells as a stack voltage.

The fuel tank 2 and the fuel supply unit 4 are connected to the line L1. The fuel supply unit 4 is connected to the cell stack structure 10 through the fuel supply line L7. Operating the fuel supply unit 4 allows the fuel in the fuel tank 2 to be supplied to the anode channel plate 22 in the cell stack structure 10 and similarly allows air to be supplied to the cathode channel plate 24 in the cell stack structure 10. Operating the load adjustment unit 8 allows the cell stack structure 10 to start generating power. The power generation unit 7 includes not only the cell stack structure 10 but also a gas-liquid separation section (not shown in the drawings) to discharge a gas generated by reaction to the exterior.

In the system shown in FIG. 9, the fuel in the fuel tank 2 is supplied directly to the cell stack structure 10. Thus, the system shown in FIG. 9 avoids including the mixture tank 5 that mixes the fuel in the mixture tank 5 with a water solution of an unreacted fuel from the cell stack structure 10 and to which the fuel in the fuel tank 2 is supplied so that the mixture tank 5 can adjust the concentration of the fuel to a predetermined value, and the circulation mechanism which feeds the fuel from the mixture tank 5 to the power generation unit 7 and which then circulates the fuel to the mixture tank 5 again. The system is thus simplified.

In the system shown in FIG. 9, if the flow rate of the fuel fed from the fuel tank 2 to the cell stack structure 10 is locally high, cells with a locally high fuel supply flow rate are subjected to an increased crossover over-voltage. On the other hand, if the flow rate of the fuel fed from the fuel tank 2 to the cell stack structure 10 is locally low, cells with a locally low fuel supply flow rate are subjected to a reduced crossover over-voltage. If the crossover over-voltage is lower than a predetermined value, the fuel is in shortage, thus disabling power generation. Thus, during system operation, a load change is caused. The crossover over-voltage of each cell is then predicted based on the value of the evaluation voltage difference ΔV obtained from the cells in the cell stack structure 10 when the load change is caused. The fuel supply unit 4 is operated so as to limit the evaluation voltage difference ΔV within the predetermined range. Consequently, the fuel can be uniformly supplied, thus improving the power generation efficiency of the system.

The technique for controlling crossover in the present system is substantially similar to that in the first embodiment, described with reference to FIG. 6. The control technique will thus be described in brief and not in detail.

First, the cell voltage monitoring unit 32 senses the voltage difference ΔVⁿ (n denotes the number of a cell to be measured) observed when the load adjustment unit 8 is operated to switch the first load to the second load. The voltage difference ΔVⁿ may be either the difference ΔV₂ⁿ between the minimum voltage value V1 and maximum voltage value V2 of each cell 16 or the difference ΔV₃ⁿ between the minimum voltage value V1 and the voltage value V3 obtained a given time after the appearance of the minimum voltage value V1.

Then, the control unit 9 determines the frequency distribution S(ΔVⁿ) of the voltage differences ΔVⁿ in the cells and determines cells with a voltage difference deviating from the frequency distribution by at least a predetermined amount to be defective. The remaining cells are determined to be normal. The control unit 9 predicts the amount of crossover from the voltage differences obtained from the voltage signals from the cells determined to be normal. The control unit 9 thus operates the fuel supply unit 4.

On the other hand, the cells determined to deviate from the frequency distribution of the voltage differences ΔV by the predetermined amount may reduce the power generation efficiency. Thus, a process is executed which recovers the defective cells to the normal state.

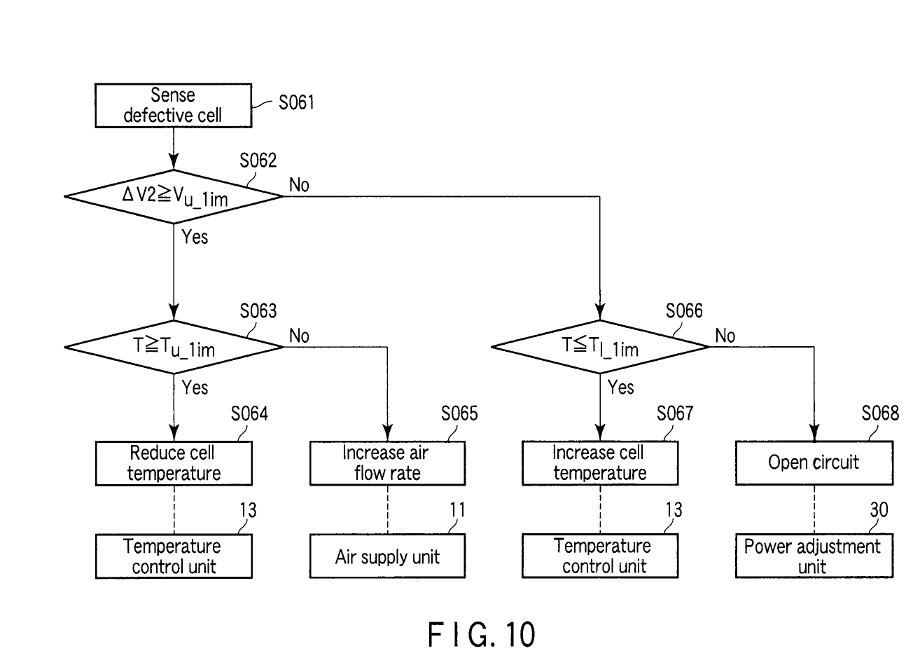

FIG. 10 is a detailed flowchart showing the process of recovering the defective cells in the system.

The system flowchart shown in FIG. 10 is pre-recorded in the database 9b in the control unit 9. The auxiliaries are operated and controlled based on relevant conditions as described below. In the description below, the voltage difference ΔV is based on the voltage difference ΔV2 between the minimum voltage value V1 and the maximum voltage value V2.

As shown in step S061, the control unit 9 determines whether or not the voltage difference ΔV₂ⁿ in the cell determined to be defective is greater than a predetermined voltage upper limit value Vᵤ_{_{—}}ₗᵢₘ. Then, if the voltage difference ΔV₂ⁿ is greater than the predetermined value Vᵤ_{_{—}}ₗᵢₘ, then the control unit 9 determines in step S063 whether or not the temperature of the power generation unit 7 is higher than a predetermined value Tᵤ_{_{—}}ₗᵢₘ. If the temperature of the power generation unit 7 is higher than the predetermined upper limit value Tᵤ_{_{—}}ₗᵢₘ, the control unit 9 determines the error in voltage difference ΔV₂ⁿ to be caused by the temperature of the power generation unit higher than the predetermined value. In step S064, the control unit provides the temperature reduction instruction to the temperature control unit 13, which then executes the process of reducing the temperature of the power generation unit 7.

If in step S062, the voltage difference ΔV₂ⁿ is greater than the predetermined voltage upper limit value Vᵤ_{_{—}}ₗᵢₘ, and in step S063, the temperature of the power generation unit 7 is lower than the predetermined upper limit value Tᵤ_{_{—}}ₗᵢₘ, then the control unit 9 determines the error in voltage difference ΔV₂ⁿ to be caused by air shortage. Then, in step S065, the control unit 9 provides the air flow rate increase instruction to the air supply unit 11, which then executes the process of increasing the flow rate of air supplied to the cell 16.

If in step S62, the voltage difference ΔV₂ⁿ in the cell determined to be defective is not greater than the predetermined voltage upper limit value Vᵤ_{_{—}}ₗᵢₘ, then in step S066, control unit 9 determines whether or not the temperature of the power generation unit 7 is lower than a predetermined lower limit temperature value Tₗ_{_{—}}ₗᵢₘ. If the temperature of the power generation unit 7 is lower than the lower limit value Tₗ_{_{—}}ₗᵢₘ, then the control unit 9 determines the error in voltage difference ΔV₂ⁿ to be caused by the temperature of the power generation unit 7 lower than the predetermined value Tₗ_{_{—}}ₗᵢₘ. Then, in step S067, the control unit 9 provides the temperature increase instruction to the temperature control unit 13, which then executes the process of increasing the temperature of the power generation unit 7.

If in step S062, the voltage difference ΔV₂ⁿ in the cell determined to be defective is not greater than the predetermined voltage upper limit value Vᵤ_{_{—}}ₗᵢₘ, and in step S066, the temperature of the power generation unit 7 is higher than the predetermined lower limit value Tₗ_{_{—}}ₗᵢₘ, then the control unit 9 determines the error in voltage difference ΔV₂ⁿ to be caused by fuel shortage. Then, in step S068, the control unit 9 can operate and place the power adjustment unit 30, which adjusts the power output to the exterior by the power generation unit 7, in an open circuit state in which the power generation unit 7 is not connected to the power load 3. In the open circuit state, CO2 remaining in the cell stack structure 10 can be discharged, allowing a variation in fuel distribution flow among the cells 16 to be eliminated.

In the system shown in FIG. 9, the flue supply flow rate is very low, and increasing the fuel supply flow rate thus fails to eliminate the variation in fuel distribution flow. Thus, the power adjustment unit 30 is switched to the open circuit state.

In the processing in steps S064, S065, and S067, after the operation is performed for a given time, the cell temperature and the air flow rate are returned to predetermined values again. Furthermore, in the processing in step S068, the power adjustment unit 30 is maintained in the open circuit state for a given time and then returned to a closed circuit state in which the power generation unit 7 is connected to the power load 31.

If at least two cells are determined to be defective, and the voltage difference in one of the defective cells is greater than the predetermined upper limit value Vᵤ_{_{—}}ₗᵢₘ, whereas the voltage difference in the other defective cell is smaller than the predetermined lower limit value Vₗ_{_{—}}ₗᵢₘ, then the operations in steps S065 and S068 may be simultaneously performed. This method allows improvement of the crossover control and thus the fuel utilization efficiency. The method also improves the system such that the defective cells can be recovered to the normal state, enabling the power generation efficiency to be increased.

The operation of recovering the defective cells does not substantially affect the normal cells. This is because an upper limit and a lower limit are typically set for the range of the operation of recovering the defective cells to the normal state so as to prevent possible problems such as a decrease in the output from the normal cell.

The configurations shown in the first to third embodiments correspond to examples of the system. Obviously, the crossover control method for the system is applicable even to cells based on a breezing scheme in which a fan used in the temperature control unit 13 is also used as an air supply unit. Furthermore, in contrast to the above-described process method, detected defective cells can be processed with the air supply unit considered to be inoperable. Furthermore, as described in JP-A2007-165148 (KOKAI), the present system is also applicable to a method of, in controlling the amount of fuel supplied to the power generation unit, operating the temperature control unit, the fuel circulation unit, the air supply unit, and the load adjustment unit but not the fuel supply unit.

Furthermore, in the systems shown in FIGS. 1 and 9, the air supply unit 11 and the temperature control unit 13 are independently provided. However, the air supply unit 11 may provide the functions of the temperature control unit 13. That is, the following operations are possible: the amount of air blown from the air supply unit 11 is increased to further cool the power generation unit 7 to reduce the temperature of the power generation unit 7, and the amount of air blown from the air supply unit 11 is reduced to inhibit cooling of the power generation unit 7 to increase the temperature of the power generation unit 7.

Additionally, the flowchart in FIG. 10, applied to FIG. 9 for the third embodiment, is also applicable to the system according to the first embodiment, shown in FIG. 1.

As described above, in the fuel cell using the liquid as a fuel, the voltage signal output from each cell is varied in conjunction with a variation in the load connected to the power generation unit. The minimum voltage and the output response value obtained after the appearance of the minimum voltage are derived from the voltage signal. The voltage difference between the minimum voltage and the output response value is collected as an inherent evaluation value of the preset unit cell. Thus, the amount of fuel supplied to the power generation unit is controlled based on the evaluation value falling within the predetermined range. Therefore, the fuel cell system allows the amount of methanol crossover to be limited within the predetermined range, enabling the power generation efficiency to be improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel cell system comprising:
a fuel tank receiving a fuel;
a mixture tank receiving a water solution of the fuel which corresponds to a dilution of the fuel;
a fuel supply unit which feeds the fuel from the fuel tank to the mixture tank;
a power generation unit configured to generate an electrical power and including cells which are stacked in the power generating unit, wherein each of the cells includes;
a membrane electrode assembly including an electrolytic membrane, an anode formed on the electrolytic membrane, and a cathode which is so formed on the electrolytic membrane as to face the anode through the electrolytic membrane,
an anode channel plate having a structure which allows to feed the fuel to the anode, and
a cathode channel plate having a structure which allows to feed air to the cathode;
a fuel circulation unit which feeds the water solution from the mixture tank to the anode through the anode channel plates;
an air supply unit which feeds the air to the cathodes through the cathode channel plates;
a load adjustment unit including first and second loads, which selects one of a first connection in which the first load is connected to the power generation unit, and a second connection in which the second load is connected to the power generation unit;
a voltage monitoring unit which monitors cell voltages output from predetermined ones of the cells to generate cell voltage signals;
a temperature adjustment unit which senses temperature of the power generation unit to control the temperature of the power generation unit; and
a control unit controlling the load adjustment unit to produce a load change in which the first connection is switched to the second connection, the control unit detecting cell voltage changes from the cell voltage signals, the voltage changes being produced in the predetermined ones of the cells respectively due to the load change, each of the voltage changes having an inherent voltage difference between a minimum voltage generated immediately after the load change and an output response voltage generated after a predetermined elapse of time from the generation of the minimum voltage, wherein the control unit selects control parameters falling within a predetermined voltage range and determines a control amount of the fuel supplied to the power generation unit based on the control parameters, and the predetermined voltage range is determined based on the distribution of the inherent voltage differences of the cells.

2. The system according to claim 1, wherein the control unit calculates an average control parameter from the control parameters, and controls the fuel supply unit in accordance with the average control parameter.

3. The system according to claim 1, wherein if the variation of the inherent voltage differences falls outside the predetermined voltage range, the control unit controls at least one of the fuel circulation unit, the air supply unit, and the temperature adjustment unit for a predetermined time so as to fall the inherent voltage differences falls within the predetermined voltage range.

4. The system according to claim 1, wherein the control unit determines the cell with the variation of the inherent voltage difference falling outside the predetermined voltage range to be defective, and if the inherent voltage difference of the defective cell is greater than an upper limit value of the predetermined voltage range, and temperature of the power generation unit is higher than an upper limit temperature, the control unit controls the temperature control unit so that the temperature of the power generation unit is reduced below a predetermined temperature value.

5. The system according to claim 1, wherein the control unit determines the cell with the variation of the inherent voltage difference falling outside the predetermined voltage range to be defective, and if the inherent voltage differences of the defective cell is greater than an upper limit value of the predetermined voltage range, and the temperature of the power generation unit falls within a predetermined temperature range, the control unit controls the air supply unit so that amount of air supplied to the power generation unit is increased above a predetermined supply value.

6. The system according to claim 1, wherein the control unit further determines the cell with the variation of the inherent voltage difference falling outside the predetermined voltage range to be defective, and if the inherent voltage difference of the cell is smaller than a lower limit value of the predetermined voltage range, and the temperature of the power generation unit is lower than a lower limit temperature value of a predetermined temperature range, the control unit controls the temperature control unit so that the temperature of the power generation unit is increased above the predetermined temperature value.

7. The system according to claim 1, wherein the control unit determines the cell with the variation of the inherent voltage difference falling outside the predetermined voltage range to be defective, and if the inherent voltage difference of the cell is smaller than the lower limit value of the predetermined voltage range, and the temperature of the power generation unit falls within a predetermined temperature range, the control unit controls the fuel circulation unit so that amount of fuel circulated to the power generation unit is increased above a predetermined supply value.

8. The system according to claim 1, wherein the control unit determines the cell with the variation of the inherent voltage difference falling outside the predetermined voltage range to be defective, and if the inherent voltage difference of the cell is smaller than the lower limit temperature value of a predetermined temperature range, and the temperature of the power generation unit falls within the predetermined voltage range, the control unit controls the load adjustment unit so as to connect the power generation unit to an open circuit to apply no load to the power generation unit.

9. The system according to claim 1, wherein the air supply unit acts as the temperature control unit.

10. The fuel cell system according to claim 1, wherein the output response voltage corresponds to a voltage maintained substantially constant after the predetermined elapse of time from the generation of the minimum voltage

11. The fuel cell system according claim 1, wherein the output response voltage corresponds to a maximum voltage appearing after reaching the minimum voltage.

12. A method of controlling a fuel cell, the method controlling amount of fuel supplied to a power generation unit including cells which are stacked in the power generating unit, wherein each of the cells includes;
a membrane electrode assembly including an electrolytic membrane, an anode formed on the electrolytic membrane, and a cathode which is so formed on the electrolytic membrane as to face the anode through the electrolytic membrane,
an anode channel plate having a structure which allows to feed the fuel to the anode, and
a cathode channel plate having a structure which allows to feed air to the cathode;
the method comprising:
monitoring cell voltages output from predetermined ones of the cells to generate cell voltage signals respectively;
generating a load change in which a first connection is switched to a second connection, wherein a first load is connected to the power generation unit in the first connection, and a second load is connected to the power generation unit in the second connection;
detecting cell voltage changes from the cell voltage signals, the voltage changes being produced in the predetermined ones of the cells respectively due to the load change, each of the voltage changes having an inherent voltage difference between a minimum voltage generated immediately after the load change and an output response voltage generated after a predetermined elapse of time from the generation of the minimum voltage;
selecting control parameters falling within a predetermined voltage range from the inherent voltage differences, wherein the predetermined voltage range is determined based on the distribution of the inherent voltage differences of the cells; and
determining a control amount of fuel supplied to the power generation unit based on the control parameters.
